(19) United States
(12) Patent Application Publication
(10) Pub. No.: US 2014/0307165 A1
(43) Pub. Date: Oct. 16, 2014

(54) INFORMATION PROCESSING APPARATUS AND OUTPUT CONTROL METHOD

(71) Applicant: KABUSHIKI KAISHA TOSHIBA, Tokyo (JP)

(72) Inventor: Hiroaki Chiba, Sagamihara-shi (JP)

(73) Assignee: KABUSHIKI KAISHA TOSHIBA, Tokyo (JP)

(21) Appl. No.: 14/149,651

(22) Filed: Jan. 7, 2014

(30) Foreign Application Priority Data
Apr. 15, 2013 (JP) 2013085229

(51) Int. Cl. H04N 7/01

(52) U.S. Cl. CPC H04N 7/01
USPC 348/441

(57) ABSTRACT

According to one embodiment, an information processing apparatus includes: a connector; a graphics controller configured to generate a video signal to be displayed on a display screen; a port setting module configured to set a port for outputting the video signal as a data transfer port that complies with a first interface standard or a second interface standard; a selector that is disposed between the port and the connector so as to connect the port to the connector; and a selector controller configured to supply to the selector a signal for connecting the port to the connector when an external unit is connected to the connector, wherein the video signal complies with the first interface standard.

### CROSS REFERENCE TO RELATED APPLICATION(S)

The application is based upon and claims the benefit of priority from Japanese Patent Application No. 2013-085229 filed on Apr. 15, 2013, the entire contents of which are incorporated herein by reference.

### BACKGROUND

1. Field

The embodiment of the present invention relates to an information processing apparatus and an output control method each concerning the connection mode between a PC (personal computer) main body and a docker having two display digital ports, for example.

2. Description of the Related Art

In general, business-oriented PCs are each provided with a docker as an extender. Hereinafter, explanation will be made as to an example of the number and kinds of display ports used for the PC main body and the docker. In recent years, it has become a mainstream to mount two digital ports such as an HDMI (trade mark, hereinafter omitted) port or a DisplayPort (hereinafter called a DP) terminal on the docker side.

For example, although the display ports of the docker of the related art have been configured by an analog RGB port and an HDMI (high-definition multimedia interface)/DVI (digital visual interface) port or a DP terminal, another HDMI/DVI port or a DP terminal is further provided recently. On the other hand, the PC main body is still provided with a built-in LCD (liquid crystal display) port, an analog RGB port and an HDMI port or a DP terminal, for example.

In order to realize the aforesaid specification, the number of the display digital ports of a chip set employed in a PC is important. However, in recent years, due to the light and compact strategy of chip set vendors, the number of the display digital ports of the chip set tends to reduce. For example, the display digital ports of the chip set of one of the vendors are as follows.

That is, the current display digital ports of the chip set are configured by six ports, i.e., a built-in LCD (LVDS) port, a built-in LCD port (eDP), an analog RGB port and three HDMI/DVI ports or DisplayPort terminals. However, the display digital ports of the chip set of the next and succeeding versions are planned to be configured by three ports, i.e., a built-in LCD port (eDP) and two HDMI/DVI ports or DisplayPort terminals.

Even if the number of the display digital ports of the chip set reduces, the number of the display digital ports supported by each of the PC and the docker does not change. Thus, there is proposed a method for complementing the reduction of the display digital ports of the chip set by using a display signal conversion IC provided by some of component vendors.

There are various ideas as to the connection of the docker, etc. such as a method of reducing the number of display signals to the docker from the PC main body, a method of minimizing the circuit size of a conversion adaptor to be connected to the DP, and a method of connecting two dockers having different kinds of display digital ports to the same PC main body and utilizing these dockers.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a perspective view showing the entire configuration of an extender according to a first embodiment of the present invention and a notebook PC as an electronic device to be connected to the extender;

FIG. 2 is a block diagram schematically showing an example of the internal configurations of the extender and the notebook PC shown in FIG. 1;

FIGS. 3A and 3B are diagrams for explaining an example of operations of a signal converter in a case that a highest priority is given to connection to an RGB socket;

FIG. 4 is an example of the embodiment (a case that the PC is an HDMI model, the docker is connected, and a DP2 connector is connected to a monitor display);

FIG. 5 is a flowchart showing an example of operations of the electronic device and the extender according to the embodiment; and

FIG. 6 is another example of the embodiment (a case that the PC is the HDMI model, the docker is connected, and the DP2 connector is connected to the monitor display).

### DETAILED DESCRIPTION

According to one embodiment, an information processing apparatus includes: a connector; a graphics controller configured to generate a video signal to be displayed on a display screen; a port setting module configured to set a port for outputting the video signal as a data transfer port that complies with a first interface standard or a second interface standard; a selector that is disposed between the port and the connector so as to connect the port to the connector; and a selector controller configured to supply to the selector a signal for connecting the port to the connector when an external unit is connected to the connector, wherein the video signal complies with the first interface standard.

Hereinafter, embodiments of this invention will be explained.

### First Embodiment

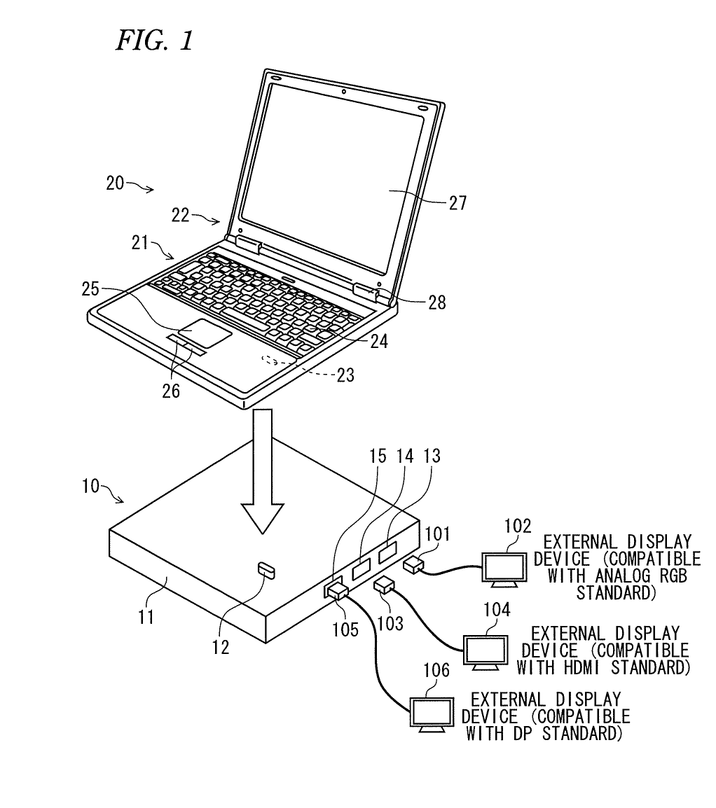

The first embodiment will be explained with reference to FIGS. 1 to 5.

An extender (commonly known as a docker) according to the embodiment is an expansion unit which extends the function of an electronic device. The extender has video output terminals in conformity with plural standards and treats signal lines relating to a video signal which are electrically coupled to the electronic device via connection terminals. The number of this signal lines is in conformity with the standard of a predetermined video signal. Hereinafter, the explanation will be made as an example as to the case where a notebook type personal computer (hereinafter called a notebook PC) is used as the electronic device connected to the extender according to the embodiment. The electronic device as an information processing apparatus is not limited to the notebook PC but may be a PDA (personal digital assistant), a portable game machine, a portable music player, a portable moving video player, or the like, so long as it has the video signal output function and is connected to the extender as an external unit.

### (1) Sample Configuration of Hardware

FIG. 1 is a perspective view showing the entire configuration of an extender 10 according to the first embodiment and a notebook PC 20 as the electronic device to be connected to the extender 10.

The extender 10 is provided with functions to be added in order to extend functions usable by a user while maintaining the portability of the notebook PC 20. To this end, the extender has a base unit 11 containing various kinds of circuits and an extender-side connection terminal 12 for electrical connection to the notebook PC 20. In the embodiment, as shown in FIG. 1, the explanation will be made as to the case where the extender 10 further has a video output terminal (RGB socket, connector) 13 that complies with the analog RGB standard which was standardized by the VESA (Video Electronics Standards Association), an HDMI socket (connector) 14 that complies with the HDMI (high-definition multimedia interface) standard, and a video output terminal (DP socket, connector) that complies with the DisplayPort standard (DP standard). Another DP socket and further another DVI socket may be provided (not shown in the figure so as to avoid the complication).

An RGB plug 101 is to be connected to the RGB socket 13. The RGB socket 13 outputs a video signal that complies with the analog RGB standard to an external display device 102 (monitor display), that is connected to the RGB plug 101 and is compatible with the analog RGB standard, via the RGB plug 101.

An HDMI plug 103 is to be connected to the HDMI socket 14. The HDMI socket 14 outputs a video signal that complies with the HDMI standard to an external display device 104, that is connected to the HDMI plug 103 and is compatible with the HDMI standard, via the HDMI plug 103. A DP plug 105 is to be connected to the DP socket 15. The DP socket 15 outputs a video signal that complies with the DP standard to an external display device 106, that is connected to the DP plug 105 and is compatible with the DP standard, via the DP plug 105.

The notebook PC 20 is equipped with a computer main body 21 and a display unit 22 as a display device. The computer main body 21 has a thin, box-shaped cabinet and the bottom surface of the cabinet is provided with a PC-side connection terminal 23 that can be electrically connected to the extender-side connection terminal 12 of the extender 10. For example, one of the extender-side connection terminal 12 and the PC-side connection terminal 23 projects from the cabinet of the extender 10 or the notebook PC 20 by a prescribed length and the other is recessed so as to be fitted with the one connection terminal 12 or 23.

A keyboard 24 serving as a manipulation unit is provided at the center portion of the top surface of the cabinet of the computer main body 21. A palm rest is formed on the front side of the upper portion of the cabinet. A touch pad 25 and touch pad buttons 26 which constitute another manipulation unit are provided at almost the central portion of the palm rest. On the other hand, the display unit 22 has a display panel 27 and is coupled to the computer main body 21 via coupling members (hinges) 28 which support the display unit 22 so that it can be opened and closed freely with respect to the computer main body.

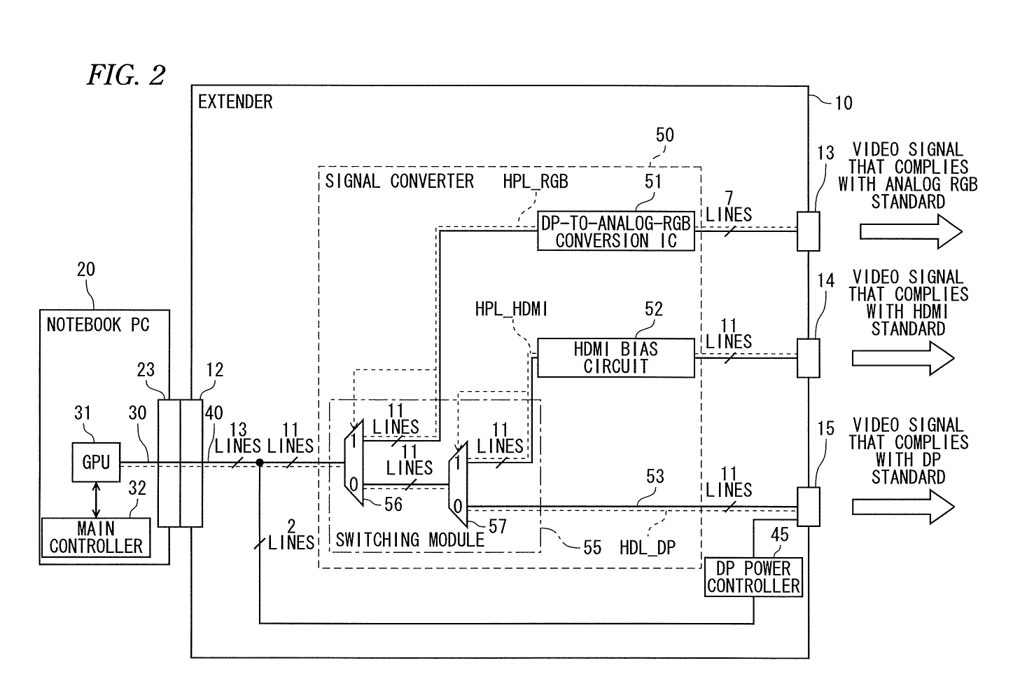

The manipulation units (keyboard 24 and touch pad 25, touch pad buttons 26) supply a main controller 32 (see FIG. 2) within the computer main body 21 of the notebook PC 20 with an input manipulation signal corresponding to a user manipulation. The display panel 27, which is a generally-known display output device such as a liquid crystal display, an OLED (organic light-emitting diode) display, or a light-emitting diode display, displays various kinds of information under the control of the main controller 32.

FIG. 2 is a block diagram schematically showing an example of the internal configurations of the extender 10 and the notebook PC 20 shown in FIG. 1.

As shown in FIG. 2, the notebook PC 20 is further equipped with signal lines 30, a GPU (graphics processing unit) 31 serving as a graphics controller having an image processing function, and the main controller 32. The number of the signal lines 30 is at least equal to a number that complies with a prescribed video signal standard. Under the control of the main controller 32, the GPU 31 outputs a video signal that complies with the prescribed video signal standard to the extender 10 via the signal lines 30 and the PC-side connection terminal 23 to which the signal lines 30 are connected. The main controller 32 is configured by a CPU, storage media such as a RAM and a ROM etc., and controls the operations of the notebook PC 20 according to programs stored in those storage media.

On the other hand, the extender 10 is further equipped with signal lines 40, a DP power controller 45, and a signal converter 50. The number of the signal lines 40 complies with the prescribed video signal standard and these signal lines are connected to the extender-side connection terminal 12.

The signal lines 40, which are electrically connected to the signal lines 30 via the PC-side connection terminal 23, supply the signal converter 50 with a video signal that is outputted from the GPU 31.

The signal converter 50 receives a video signal that complies with the prescribed video signal standard from the GPU 31 via the signal lines 30, the PC-side connection terminal 23, the extender-side connection terminal 12, and the signal lines 40. The signal converter 50 converts the received video signal which complies with the prescribed video signal standard inputted from the GPU 31 via the signal lines 40 into a video signal that complies with the video signal standard corresponding to one of the video output terminals 13 to 15 of the extender 10, and outputs the video signal thus converted to the corresponding one video output terminal.

For example, assumption is made that the extender 10 has video output terminals that respectively comply with first and second standards and the GPU 31 outputs a video signal that complies with a third standard. In this case, when receiving a video signal that complies with the third standard, the signal converter 50 converts the received video signal into a video signal that complies with the first standard and outputs it to the video output terminal that complies with the first standard. Alternatively, the signal converter 50 converts the received video signal into a video signal that complies with the second standard and outputs it to the video output terminal that complies with the second standard.

When the standard corresponding to a destination video output terminal is the same as the standard corresponding to a video signal that is outputted from the GPU 31, the signal converter 50 outputs a video signal that complies with this same standard. This means that the signal converter 50 outputs the received video signal to the target video output terminal as it is without converting it.

The following description will be made as to a case that the extender 10 is equipped with the RGB socket 13, the HDMI socket 14, and the DP socket 15, and the GPU 31 outputs a video signal that complies with the physical layer standard and the logical layer standard of the DP standard (i.e., a video signal that complies with the DP standard) or a video signal that complies with the logical layer standard of the HDMI standard, via the signal lines 30 and 40 that comply with the DP standard.

In this case, the number of lines of each of the set of signal lines 30 and the set of signal lines 40 is at least equal to the number that complies with the DP standard. The number of lines that complies with the DP standard is eleven. That is, ten lines are used for transmission of differential signals (two lines are sideband signal lines corresponding to signal lines for transmission of a DDC (VESA display data channel) signal that complies with the HDMI standard or the like) and one line is used for transmission of a hot plug signal.

The embodiment is directed to a case that each of the set of signal lines 30 and the set of signal lines 40 further has two signal lines for power control via which the GPU 31 supplies an instruction to the DP power controller 45. Therefore, each of the set of signal lines 30 and the set of signal lines 40 has 13 lines in total.

The number of lines that complies with the analog RGB standard is seven. That is, three lines are used for transmission of R, G, and B signals, two lines are used for transmission of a sync signal, and two lines are used for transmission of a DDC signal. The number of lines that complies with the HDMI standard is eleven. That is, eight lines are used for transmission of differential signals, two lines are used for transmission of a DDC signal, and one line is used for transmission of a hot plug signal.

The DP power controller 45 is controlled by the GPU 31 via the two signal lines for power control and controls the supply of power to the DP socket 15.

The signal converter 50 is equipped with a DP-to-analog-RGB conversion IC (integrated circuit) (hereinafter referred to as an RGB converter) 51, an HDMI bias circuit (hereinafter referred to as an HDMI converter) 52, and a DP converter 53. Signal lines that comply with the same video standard as the signal lines 30 and 40 are connected to the video signal input side (GPU 31 side) of each of the converters 51 to 53. Sets of signal lines that comply with the video signal standards corresponding to the sockets 13 to 15 are connected to the video signal output sides (the sides of the sockets 13 to 15) of the converters 51 to 53, respectively.

The RGB converter (DP-to-analog-RGB conversion IC) 51 converts a video signal, that is outputted from the GPU 31 and complies with the DP standard, into a video signal that complies with the analog RGB standard and outputs the video signal thus converted to the RGB socket 13.

Furthermore, the RGB converter 51 monitors the output electric potential of the RGB socket 13. The RGB socket 13 outputs a high-level electric potential when the RGB plug 101 is connected to this socket, whilst outputs a low-level electric potential when the RGB plug 101 is not connected to this socket. The RGB converter 51 utilizes the output electric potential of the RGB socket 13 as a connection recognition signal to thereby generate a signal (HPL_RGB signal) that is equivalent to a hot plug signal (HPL_HDMI signal) to be outputted from the HDMI socket 14 and a hot plug signal (HPL_DP signal) to be outputted from the DP socket 15, and then output the signal thus generated to the signal lines on the GPU 31 side.

In other words, the RGB socket 13 is configured so as to output the connection recognition signal to the signal converter 50 when the RGB plug 101 is connected to this socket. The HDMI socket 14 outputs a hot plug signal (connection recognition signal) to the signal converter 50 when the HDMI plug 103 is connected to this socket. Also, the DP socket 15 outputs a hot plug signal to the signal converter 50 when the DP plug 105 is connected to this socket. In FIG. 2, signal lines for transmission of the connection recognition signals are drawn by broken lines.

The HDMI converter (HDMI bias circuit) 52 converts a video signal, that is outputted from the GPU 31 and complies with the logical layer standard of the HDMI standard, into a video signal that complies with the physical layer standard of the HDMI standard by adjusting a bias voltage (physical layer information) of the former video signal, and outputs the video signal thus converted to the HDMI socket 14. As a result, the video signal that is outputted from the HDMI converter 52 is a video signal that complies with the physical layer standard and the logical layer standard of the HDMI standard.

The HDMI converter 52 receives the hot plug signal (HPL_HDMI signal) that is outputted from the HDMI socket 14, and outputs the hot plug signal to the signal lines on the GPU 31 side as it is.

The DP converter 53 is a member for outputting a video signal, that is outputted from the GPU 31 and complies with the DP standard, to the DP socket 15 as it is. The DP converter 53 is therefore formed by simple wiring lines (signal lines) that comply with the DP standard.

The DP converter 53 receives the hot plug signal (HPL_DP signal) that is outputted from the DP socket 15, and outputs the hot plug signal to the signal lines on the GPU 31 side as it is.

The connection recognition signal that is supplied to the signal converter 50 is transferred to the GPU 31 via the signal lines 40, the extender-side connection terminal 12, the PC-side connection terminal 23, and the signal lines 30.

This embodiment is directed to a case that the signal converter 50 outputs a video signal to a selected one of the sockets 13 to 15. In this case, the signal converter 50 has a switching module 55.

The switching module 55 is equipped with a first multiplexer (hereinafter referred to as a first MUX) 56 and a second multiplexer (hereinafter referred to as a second MUX) 57.

The first MUX 56 supplies a video signal that is received from the GPU 31 to one of the RGB converter 51 and the second MUX 57. The first MUX 56 receives, as a switching control signal, the HPL_RGB signal that is generated from the RGB converter 51 by converting the connection recognition signal outputted from the RGB socket 13.

For example, the HPL_RGB signal is inputted to the first MUX 56 as the switching control signal via a new single signal line obtained by one-to-two branching of one signal line for transmission of a hot plug signal that is included in the signal lines that connect between one output terminal of the first MUX 56 and the RGB converter 51.

As shown in FIG. 2 as an example, the first MUX 56 connects the signal lines 40 to the RGB converter 51 when the HPL_RGB signal is at a high level (indicated by a number “1” in the first MUX 56 in FIG. 2), whilst connects the signal lines 40 to the second MUX 57 when the HPL_RGB signal is at a low level (indicated by a number “0” in the first MUX 56 in FIG. 2). In the following description, the connection recognition signal at the high level is represented by “1” and the connection recognition signal at the low level is represented by “0”.

The second MUX 57 supplies the video signal received from the first MUX 56 to one of the HDMI converter 52 and the DP converter 53. The second MUX 57 receives, as a switching control signal, via the HDMI converter 52, the connection recognition signal (HPL_HDMI signal) that is outputted from the HDMI socket 14.

Also, the HPL_HDMI signal is input to the second MUX 57 as the switching control signal via, for example, a new single signal line obtained by one-to-two branching of one signal line for transmission of a hot plug signal that is included in the signal lines that connect between one output terminal of the second MUX 57 and the HDMI converter 52.

As shown in FIG. 2 as an example, the second MUX 57 connects the first MUX 56 to the HDMI converter 52 when the HPL_HDMI signal is at the high level “1”, whilst connects the first MUX 56 to the DP converter 53 when the HPL_HDMI signal is at the low level “0”.

### (2) Operations in a Case that Highest Priority is Given to Connection to RGB Socket 13

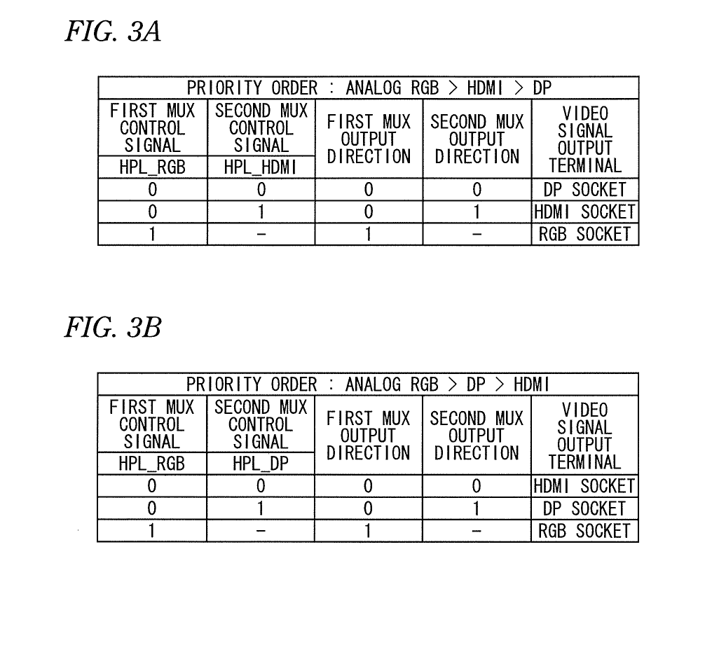

FIGS. 3A and 3B show example operations of the signal converter 50 in a case that the highest priority is given to connection to the RGB socket 13. More specifically, FIG. 3A shows an example operation of the signal converter 50 in a case that a higher priority is given to connection, performed by the extender 10 shown in FIG. 2, to the HDMI socket 14 than connection to the DP socket 15. FIG. 3B shows an example operation of the signal converter 50 in a case that a higher priority is given to connection to the DP socket 15 than connection to the HDMI socket 14.

(2-1) Case that Higher Priority is Given to Connection to HDMI Socket 14 than Connection to DP Socket 15

As shown in FIGS. 2 and 3A, in the configuration of FIG. 2, the highest priority is given to connection to the RGB socket 13 and a higher priority is given to connection to the HDMI socket 14 than connection to the DP socket 15. More specifically, when the RGB plug 101 is connected to the RGB socket 13 and hence the HPL_RGB signal is inputted to the first MUX 56 (that is, the HPL_RGB signal is at the high level “1”), a video signal received from the GPU 31 is supplied to the RGB converter 51 irrespective of connection statuses of the other sockets 14 and 15. Then, the RGB converter converts the video signal into a video signal that complies with the analog RGB standard, and outputs the video signal thus converted to the RGB socket 13.

When the RGB plug 101 is not connected to the RGB socket 13 and hence the HPL_RGB signal is not inputted to the first MUX 56 (that is, the HPL_RGB signal is at the low level “0”), and further when the HDMI plug 103 is connected to the HDMI socket 14 and hence the HPL_HDMI signal is inputted to the second MUX 57 (that is, the HPL_HDMI signal is at the high level “1”), a video signal received from the GPU 31 is supplied to the HDMI converter 52 irrespective of the connection status of the DP socket 15. Then, the HDMI converter converts the video signal into a video signal that complies with the HDMI standard, and outputs the video signal thus converted to the HDMI socket 14.

For example, consideration will be made as to a case that the RGB plug 101 is connected to the RGB socket 13. In this case, since the HPL_RGB signal at the high level “1” is generated, the first MUX 56 connects the signal lines 40 to the RGB converter 51 irrespective of connection statuses of the other sockets 14 and 15. As a result, the signal lines 40 are electrically connected to the RGB converter 51, whilst the signal lines 40 are disconnected from the other sockets 14 and 15.

Thus, the RGB socket 13 is electrically connected to the GPU 31 of the notebook PC 20 via the RGB converter 51 and the first MUX 56. Therefore, the HPL_RGB signal that is generated by the RGB converter 51 on the basis of the connection recognition signal outputted from the RGB socket 13 is supplied to the GPU 31.

When receiving the HPL_RGB signal, the GPU 31 receives information representing that the external display device 102 connected to the RGB socket 13 is a display device that is compatible with the analog RGB standard. In this respect, the information is in the form of data having, for example, the EDID (extended display identification data) format sent from the external display device 102 via the DDC signal lines. Then, the GPU 31 outputs a video signal that complies with the DP standard to the signal lines 30 which comply with the DP standard. This video signal is supplied to the RGB converter 51 and converted into a video signal that complies with the analog RGB standard. Then, the RGB converter outputs the video signal thus converted to the analog-RGB-compatible external display device 102 via the RGB socket 13 and the RGB plug 101.

Consideration will be made as to another case that the HDMI plug 103 is connected to the HDMI socket 14 and no plugs are connected to the other sockets 13 and 15. In this case, the HPL_RGB signal at the low level “0” and the HPL_HDMI signal at the high level “1” are generated. Therefore, the first MUX 56 connects between the signal lines 40 and the second MUX 57, and the second MUX 57 connects between the first MUX 56 and the HDMI converter 52.

Thus, the HDMI socket 14 is electrically connected to the GPU 31 of the notebook PC 20 via the HDMI converter 52, the second MUX 57, and the first MUX 56. Therefore, the HPL_HDMI signal outputted from the HDMI socket 14 is supplied to the GPU 31. When receiving the HPL_RGB signal, the GPU 31 receives information representing that the external display device 104 connected to the HDMI socket 14 is a display device that is compatible with the HDMI standard. In this respect, the information is in the form of data having, for example, the EDID format sent from the external display device 104 via the DDC signal lines.

Then, the GPU 31 outputs a video signal that complies with the logical layer standard of the HDMI standard to the signal lines 30 which comply with the DP standard. The video signal is supplied to the HDMI converter 52 and converted, through bias voltage (physical layer information) adjustment, into a video signal that complies with the physical layer standard of the HDMI standard. Then, the video signal thus converted is outputted to the HDMI-compatible external display device 104 via the HDMI socket 14 and the HDMI plug 103.

For still another example, consideration will be made as to a case that the DP plug 105 is connected to the DP socket 15 and no plugs are connected to the other sockets 13 and 14. In this case, the HPL_RGB signal at the low level “0” and the HPL_HDMI signal at the low level “0” are generated. Therefore, the first MUX 56 connects between the signal lines 40 and the second MUX 57 and the second MUX 57 connects between the first MUX 56 and the DP converter 53.

Thus, the DP socket 15 is electrically connected to the GPU 31 of the notebook PC 20 via the DP converter 53, the second MUX 57, and the first MUX 56. Therefore, the HPL_DP signal outputted from the DPI socket 15 is supplied to the GPU 31. When receiving the HPL_DP signal, the GPU 31 receives information representing that the external display device 106 connected to the DP socket 15 is a display device that is compatible with the DP standard. In this respect, the information is in the form of data having, for example, the EDID format sent from the external display device 106 via the DDC signal lines.

Then, the GPU 31 outputs a video signal that complies with the DP standard to the signal lines 30 which comply with the DP standard. This video signal is supplied to the DP converter 53 and then supplied to the DP socket 15 as it is. Then, this video signal is outputted to the DP-compatible external display device 106 via the DP socket 15 and the DP plug 105.

(2-2) Case that Higher Priority is Given to Connection to DP Socket 15 than Connection to HDMI Socket 14

As shown in FIG. 3B, the configuration of FIG. 2 may be modified in a manner that the HPL_DP signal is inputted to the second MUX 57 as the switching control signal instead of the HPL_HDMI signal. In this configuration, the highest priority is given to connection to the RGB socket 13 and a higher priority is given to connection to the DP socket 15 than connection to the HDMI socket 14.

In the case where the signal converter 50 outputs a video signal to selected one of the sockets 13 to 15, an arbitrary priority order can be set by properly setting a manner of connections between the switching module 55 and the respective converters 51 to 53 and determining the switching control signals to be inputted to the switching module 55.

### (3) Functional Configuration and Operation of Embodiment

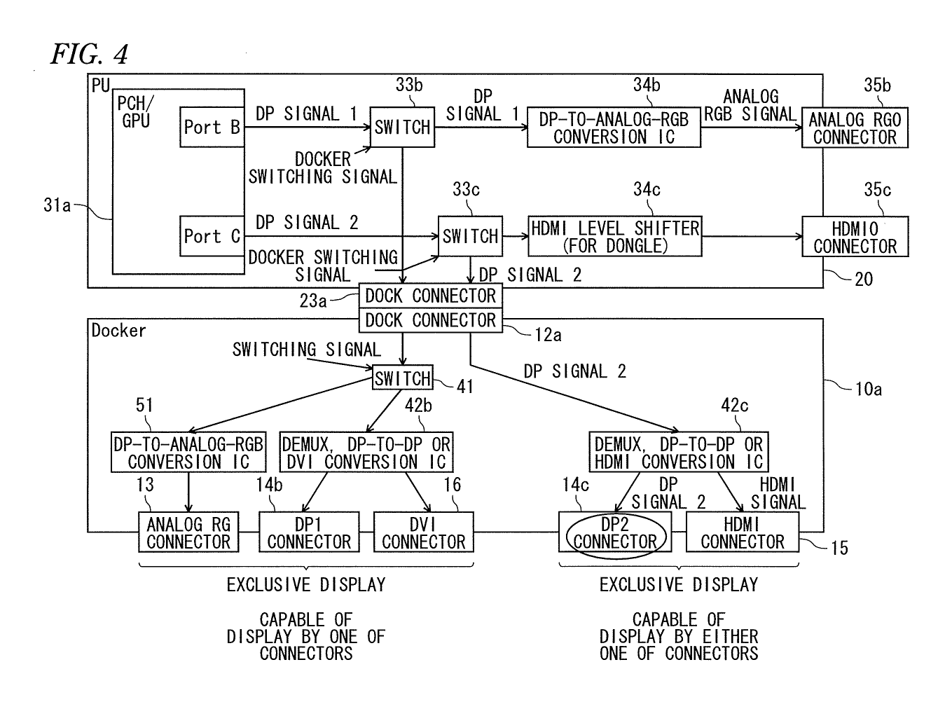

FIG. 4 shows, as an example of this embodiment, a state where the PC of an HDMI model is connected to the extender 10 (hereinafter referred to as a docker). In this figure, portions having the corresponding functions to those of FIGS. 1 and 2 are referred to by the common symbols, respectively. A DP model and the HDMI model are known as typical examples of the models of the PC. For example, in a case that the PC is equipped with another connector for the external display device in addition to the analog RGB connector, the PC of the DP model is equipped with the DP connector, whilst the PC of the HDMI model is equipped with the HDMI connector.

In FIG. 4, a PCH/GPU 31a has a function of PCH (platform controller hub) in addition to the function of the GPU 31. The PCH is a chip that is formed by integrating functions of I/O controllers of various kinds of devices, for example. The main controller 32 outputs the switching control signals to switches or MUXs etc. via the PCH and a not shown GPIO (general purpose input/output) in accordance with instruction information inputted by a user.

The PCH/GPU 31a (hereinafter referred to as a PCH) may be configured that a video signal to be displayed on the display screen generated from the GPU of the information processing apparatus according to this embodiment is outputted from the GPU when the GPU is provided as an external device of the main controller 32, whilst the video signal is outputted from the PCH when the GPU is contained within the main controller 32.

In FIG. 4, a port A for outputting a signal to the built-in LCD constituting the display panel 27 is omitted.

Hereinafter, explanation will be made as to each of the DP model and the HDMI model with reference to the following table.

TABLE 1

| Model | Paragraph | Docker | Output | Remarks |
|---|---|---|---|---|
| DP | 3-1-1 | Not | RGBO, DPO | |
| | | connected | | |
| | 3-1-2 | Connected | DP1 etc., | |
| | | | DP2 | |
| | 3-1-3 | Connected | DVI, HDMI | |
| HDMI | 3-2-1 | Notconnected | RGB0, HDMI0 | |
| | 3-2-2 | Connected | DP2 | NG until |
| | | | | reboot |
| | 3-2-3 | Connected | DP2 | |

(3-1) Case of DP Model

Before explaining the problem of the HDMI model and a countermeasure against the problem according to this embodiment, the operation of the DP model will be explained for the sake of the comparison with the HDMI model. In this case, assumption is made that the configuration of the notebook PC shown in FIG. 4 is modified in a manner that an HDMI0 connector 35c is replaced by a DP connector and an HDMI level shifter 34c is eliminated, whereby one of the outputs of a switch 33c is directly connected to the DP connector.

(3-1-1) Case that Docker is not Connected

In this case, it is assumed that each of the analog RGB connector and the DP connector is connected to the monitor display. Firstly, at a time of booting the PC (PC 20), a BIOS sets DP signals as the outputs of the port B and the port C of the PCH, respectively. The DP signals of the port B and the port C are transmitted to the DP-to-analog-RGB conversion IC 34b (having substantially same function as the RGB converter 51) and the DP connector via the switches on the PC main body side, respectively.

That is, the DP signal 1 is converted into an analog RGB signal by the DP-to-analog-RGB conversion IC 34b and transmitted to an analog RGB0 connector 35b. The DP signal 2 is directly transmitted to the DP connector as it is.

(3-1-2) Case that Docker is Connected and Both DP1 Connector and DP2 Connector are Connected to Monitor Display

At a time of booting the PC, the BIOS sets DP signals as the outputs of the port B and the port C of the PCH, respectively. When the docker (docker 10a, hereinafter merely referred to as a docker) is connected to the main body, the switches on the PC main body side are switched by switching control signals (docker switching signals) via the GPIO, for example, thereby transmitting the DP signals from the port B and the port C to a dock connector 23a (having function of the connector 23 for each of these two DP signals).

The DP signal 1 is transmitted to a DeMUX (DP-to-DP or DVI conversion IC) 42b via a switch 41 (having substantially same function as the switch 56) on the docker side and thereafter transmitted to a DP1 connector 14b. The DP signal 2 is transmitted to a DeMUX (DP-to-DP or HDMI conversion IC) 42c (having substantially same functions as the DP power controller 45, the HDMI converter 52, the DP converter 53 and the second MUX 57) without passing through the switch 41 and thereafter transmitted to a DP2 connector 14c.

If the DP1 connector 14b is disconnected from the monitor display and the analog RGB connector 13 is connected to the analog RGB monitor display, the switch 41 on the docker side is switched to the DP-to-analog-RGB conversion IC 51 under the control of a hog plug signal supplied via the analog RGB connector 13, for example, to thereby transmit the DP signal 1 to the RGB converter. The DP signal 1 is converted into an analog RGB signal by the DP-to-analog-RGB conversion IC 51 and transmitted to the analog RGB connector 13.

(3-1-3) Case that Docker is Connected and Monitor Display is Connected to DVI Connector and HDMI Connector

At a time of booting the PC, the BIOS sets DP signals as the output signals of the port B and the port C of the PCH, respectively. When the docker is connected, the switches on the PC main body side are switched. In this case, the output of the port B is switched from the DP signal to the HDMI signal and the output of the port C is switched from the DP signal to the DVI signal (see note 1 described bellow).

The DVI signal from the DeMUX (DP-to-DP or DVI conversion IC) 42b is transmitted to a DVI connector 16. The HDMI signal from the DeMUX (DP-to-DP or HDMI conversion IC) 42c is transmitted to the HDMI connector 15.

(Note 1) Specification for supporting the HDMI/DVI is defined in the specification of the DP. This DP is called a dual mode DP. In the aforesaid case, such the dual mode DP can automatically switch the output of each of the port B and the port C to the HDMI or DVI signal from the DP signal.

(3-2) Case of HDMI Model

In each of the following cases (3-2-1) and (3-2-2), like the conventional case, assumption is made that the configuration of the notebook PC shown in FIG. 4 is modified in a manner that the HDMI level shifter 34c is eliminated, whereby one of the outputs of the switch 33c (having substantially same function as the switch 41) is directly connected to the HDMI0 connector 35c.

(3-2-1) Case that Docker is not Connected and Both Analog RGB0 Connector and HDMI0 Connector are Connected to Monitor Display

At a time of booting the PC, the BIOS sets the DP signal as the output of the port B and the HDMI signal as the output of the port C of the PCH. The output signals from the port B and the port C are transmitted to the dock connector 23a side via the switches on the PC main body side.

That is, the DP signal is converted into the analog RGB signal by the DP-to-analog-RGB conversion IC 34b and transmitted to the analog RGB0 connector 35b. The HDMI signal is directly transmitted to the HDMI0 connector 35c as it is.

(3-2-2) Case that Docker is Connected and Monitor Display is Connected to DP2 Connector

At a time of booting the PC, the BIOS sets the DP signal as the output of the port B and the HDMI signal as the output of the port C of the PCH. When the docker is connected, the switch on the PC main body side is switched to thereby transmit the HDMI signal from the port C to the dock connector 23a.

Since the monitor display is connected to the DP2 connector 14c, the HDMI signal from the port C is transmitted to the DP2 connector side. However, since the input signal toward the DP2 connector side is the HDMI signal, this HDMI signal is not transmitted to the DP2 connector 14c. Thus, when the PC side is rebooted once (problem relating to the mode of the next case (3-2-3)), the BIOS changes the setting of the output of the port C to the DP signal. As a result, a video signal is displayed on the monitor display connected to the DP2 connector 14c.

(3-2-2) Case that Docker is Connected and Monitor Display is Connected to DP2 Connector

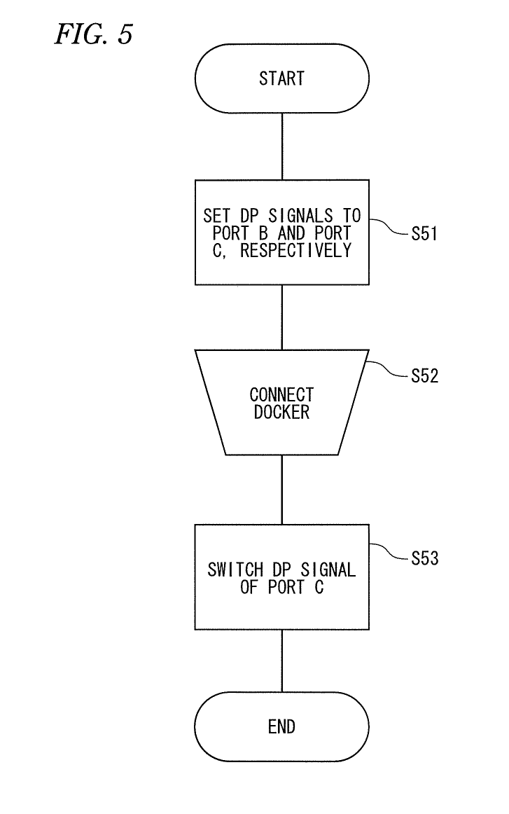

Returning to FIG. 4, this embodiment will be explained with reference to a flowchart shown in FIG. 5 which mainly relates to a selector. This selector is configured by combining the switch 33c and the HDMI level shifter 34c. The selector may be controlled by a signal such as a hot plug signal applied via the dock connector 23a as well as the aforesaid switching control signal.

Firstly, at a time of booting the PC, the BIOS sets DP signals as the output signals of the port B and the port C of the PCH, respectively (step S51). When the docker is connected (step S52), the switch 33c on the PC main body side switches the DP signal 2 of the port C to the dock connector 23a side (step S53). Thus, the DP signal 2 is transmitted to the DP2 connector 14c via the DeMUX (DP-to-DP or HDMI conversion IC) 42c. As a result, the DP signal is displayed on the monitor display via the DP2 connector 14c.

The feature of this embodiment resides in that the “HDMI level shifter for dongle” is disposed on the HDMI signal line of the PC main body. Thus, the BIOS as the port setting module may set the DP signal as the output of the port C irrespective of the connection state of the docker. This is because, when the monitor display is connected to the HDMI0 connector of the PC main body, the output of the port C is automatically switched to the HDMI signal from the DP signal due to the DP dual mode function (dual mode PC is compatible with the DVI or HDMI output by applying a TMDS (Transition Minimized Differential Signaling) signal to the DisplayPort).

That is, the HDMI level shifter 34c adjusts the bias voltage (information of the physical layer) of a signal received from the switch 33c (adjusts the bias voltage of a signal which DC level is not adjusted) while holding the ID of the HDMI for the sake of dongle, to thereby convert the signal to a signal that complies with the physical layer standard of the HDMI standard. As a result, an output signal of the HDMI level shifter 34c becomes a video signal that complies with the physical layer standard and the logical layer standard of the HDMI standard.

### Second Embodiment

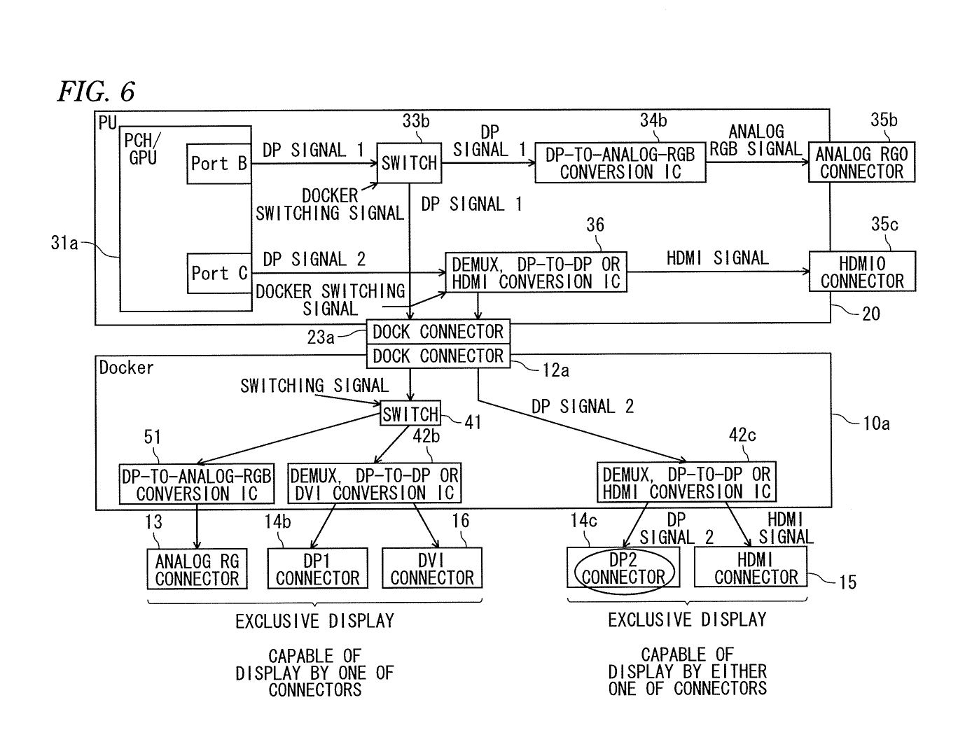

The second embodiment according to this invention will be explained with reference to FIGS. 5 and 6. In this embodiment, explanation concerning portions common to those of the first embodiment will be omitted.

FIG. 5 is a flowchart showing an example of the operation of an electronic device and an extender according to this embodiment. This flowchart mainly relates to a selector like the first embodiment. In FIG. 6, a DeMUX (DP-to-DP or HDMI conversion IC) 36 is used as the selector.

Like the case (3-2-3), assumption is made that the PC main body is the HDMI model, the docker is connected and the monitor display is connected to the DP2 connector.

At a time of booting the PC, the BIOS sets DP signals as the output signals of the port B and the port C of the PCH, respectively (step S51). When the docker is connected (step S52), the DP signal 2 is transmitted to the docker side by the DeMUX (DP-to-DP or HDMI conversion IC) 36 as a switch (step S53). Thereafter, the DP signal 2 is transmitted to the DP2 connector 14c via the DeMUX (DP-to-DP or HDMI conversion IC) 42c. As a result, the DP signal is displayed on the monitor display via the DP2 connector 14c.

According to the embodiments described above, even in the case of the chip set having a small number of the display digital ports, the docker can be connected and disconnected without rebooting the PC irrespective of the model (HDMI model/DP model) of the PC main body.

That is, in the PC system employing the configuration that the chip set equipped with three display digital ports is employed and the numbers of internal display device and external display devices are 1 and 2, respectively, there is provided with a method which can connect/disconnect the docker having two display digital ports without rebooting the PC system even if the PC main body is the HDMI model. The explanation is made as to the method of connecting to the docker having two display digital ports.

This invention is not limited to the aforesaid embodiments and can be implemented by changing and modifying in various manners within a range not departing from the gist of the invention.

Further, viperous kinds of inventions can be achieved by suitably combining the constitutional elements disclosed in the aforesaid embodiments. For example, some of the entire constitutional elements disclosed in each of the embodiment may be deleted. Further, the constitutional elements disclosed in the respective embodiments may be suitably and selectively combined.

What is claimed is:

1. An information processing apparatus comprising:
a connector;
a graphics controller configured to generate a video signal to be displayed on a display screen;
a port setting module configured to set a port for outputting the video signal as a data transfer port that complies with a first interface standard or a second interface standard;
a selector that is disposed between the port and the connector so as to connect the port to the connector; and
a selector controller configured to supply to the selector a signal for connecting the port to the connector when an external unit is connected to the connector, wherein
the video signal complies with the first interface standard.

2. The information processing apparatus according to claim 1, wherein
the first interface standard is DisplayPort, and the second interface standard is High-Definition Multimedia Interface (HDMI).

3. The information processing apparatus according to claim 1, wherein
the video signal is previously adjusted to the first interface standard.

4. An output control method of a video signal in an information processing apparatus, comprising:
setting a port for outputting a video signal generated by a graphics controller as a data transfer port that complies with a first interface standard or a second interface standard;
when an external unit is connected to a connector, supplying a signal for connecting the port to the connector, to a selector that is adapted to connect the port to the selector, wherein in this case, the video signal complies with the first interface standard.

5. The output control method of a video signal according to claim 4, wherein
the first interface standard is DisplayPort, and the second interface standard is High-Definition Multimedia Interface (HDMI).

6. The output control method of a video signal according to claim 4, wherein
the video signal is previously adjusted to the first interface standard.
